(19) United States
(12) Patent Application Publication
(10) Pub. No.: US 2016/0104962 A1
(43) Pub. Date: Apr. 14, 2016

(54) CONNECTOR DEVICE

(71) Applicant: HYUNDAI MOTOR COMPANY, Seoul (KR)

(72) Inventor: Cheol Hun LEE, Suwon-si (KR)

(21) Appl. No.: 14/737,447

(22) Filed: Jun. 11, 2015

(30) Foreign Application Priority Data
Oct. 14, 2014 (KR) 10-2014-0138511

(51) Int. Cl. H01R 13/453; H01R 13/629

(52) U.S. Cl. CPC H01R 13/4532; H01R 13/629

(57) ABSTRACT

A connector device includes: a male connector having terminals formed therein; and a protector guide provided in the male connector so as to be openable or closeable. The protector guide is fixed by elastic force of elastic bodies before connecting a target connector to prevent exposure of the terminals assembled to the connector, thereby making it possible to prevent warpage, deformation, damage, and the like, of the terminals due to external force and prevent introduction of external foreign materials, and the target connector may be inserted along an accurate trajectory at the time of connection of the connector to induce accurate connection between the connector and the terminals, thereby making it possible to improve an assembling property.

### CROSS-REFERENCE TO RELATED APPLICATION

This application is based on and claims the benefit of priority to Korean Patent Application No. 10-2014-0138511, filed on Oct. 14, 2014 in the Korean Intellectual Property Office, the disclosure of which is incorporated herein in its entirety by reference.

### TECHNICAL FIELD

The present disclosure relates to a connector device, and more particularly, to a connector device that is capable of blocking deformation of a terminal of a male connector due to external force and the possibility that foreign materials may be introduced by preventing the terminal from being exposed to the outside and is capable of confirming a connector connection state through a protector guide for protecting the terminal.

### BACKGROUND

Generally, a connector means a device connecting connection devices connectable to the connector to each other to allow a current to flow between the connection devices. The connector has a space formed therein so as to accommodate a terminal therein.

Meanwhile, in the connector for a vehicle, the number of connector circuits for circuit processing has increased due to an increase in wirings for various information and signals for driving of the vehicle and an operation of a device and an increase in electric components depending on an increase in convenience devices such as a multimedia, a global positioning system (GPS), an information communication device, and the like.

In accordance with the increase in the number of circuits as described above, a multipolar circuit connector is required. Therefore, a size of a female receiving part of a male connector are increased, such that a terminal may be easily exposed to an external environment, thereby causing problems such as damage, deformation, and warpage of the terminal, introduction of foreign materials, or the like.

In order to solve this problem, in the related art, a disposable or reusable terminal protecting cover has been used. However, it is difficult to withdraw the cover and it is difficult to confirm whether or not the connector is connected, such that workability is deteriorated, and a structure is complicated, such that salability is deteriorated.

### RELATED ART DOCUMENT

Patent 1: Korean Patent Laid-Open Publication No. 10-2012-0001323

### SUMMARY

The present disclosure has been made to solve the above-mentioned problems occurring in the prior art while advantages achieved by the prior art are maintained intact.

An aspect of the present disclosure provides a connector device that is capable of blocking deformation of a terminal of a male connector due to external force and the possibility that foreign materials may be introduced by preventing the terminal from being exposed to the outside and is capable of confirming a connector connection state through a protector guide for protecting the terminal.

According to an exemplary embodiment of the present disclosure, a connector device includes: a male connector having terminals formed therein; and a protector guide provided in the male connector so as to be openable or closeable.

The male connector may be provided with an opening part, and the protector guide may be formed in the opening part.

The protector guide may include a first protector guide and a second protector guide.

The first protector guide and the second protector guide may be disposed in parallel with each other and be rotated downward based on the center to thereby be opened or closed.

The connector device may further include shafts formed at one end of the first protector guide and the other end of the second protector guide and rotatably mounted in the opening part.

The connector device may further include elastic bodies mounted on the shafts and providing elastic force to the first protector guide and the second protector guide to open or close the protector guide.

A through-hole may be formed at an outer side of the male connector in which the opening part is formed to allow the opening or the closing of the protector guide to be confirmed.

The first protector guide and the second protector guide may have a color different from that of the male connector to allow the protector guide to be easily identified at the time of confirming the opening or the closing of the protector guide.

A latch may be provided at an inner side of the opening part to limit opening of the first protector guide and the second protector guide.

The latch may be movably provided to move the first protector guide and the second protector guide downward at the time of generation of external force in the first protector guide and the second protector guide, thereby enabling the protector guide to be opened.

According to an exemplary embodiment of the present disclosure, a connector device includes: a male connector having terminals formed therein; a protector guide provided in the male connector so as to be openable or closeable and including a first protector guide and a second protector guide; and shafts formed at one end of the first protector guide and the other end of the second protector guide; and elastic bodies mounted on the shafts and providing elastic force to the first protector guide and the second protector guide to open or close the protector guide.

According to an exemplary embodiment of the present disclosure, a connector device may include a male connector having a housing with an open end and terminals formed inside of the housing, and a rotatable protector guide coupled to an edge of the open end of the housing.

The rotatable protector guide may be rotatable between a first position and a second position.

The terminals may be shielded from an exterior of the connector device by the rotatable protector guide at the first position.

A first distance between the rotatable protector guide and the terminals when the rotatable protector guide is positioned at the first position, may be greater than a second distance between the rotatable protector guide and the terminals when the rotatable protector guide is positioned at the second position.

The rotatable protector guide may be biased by a restore force towards the first position provided by an elastic body, upon offsetting from the first position.

### BRIEF DESCRIPTION OF THE DRAWINGS

The above and other objects, features and advantages of the present disclosure will be more apparent from the following detailed description taken in conjunction with the accompanying drawings.

FIG. 1 is an exploded perspective view showing a connector device according to an exemplary embodiment of the present disclosure.

FIG. 2 is a perspective view showing the connector device according to an exemplary embodiment of the present disclosure.

FIGS. 3(a) to 3(f) are views showing a state in which a target connector is inserted into a male connector in the connector device according to an exemplary embodiment of the present disclosure.

FIGS. 4(a) to 4(f) are cross-sectional views showing the state in which the target connector is inserted into the male connector in the connector device according to an exemplary embodiment of the present disclosure.

FIG. 5 is a view showing an elastic body mounted in a protector guide in the connector device according to an exemplary embodiment of the present disclosure.

FIGS. 6(a) to 6(c) are views showing a state in which opening of the protector guide is limited by a latch in the connector device according to an exemplary embodiment of the present disclosure.

FIGS. 7(a) to 7(c) are views showing a state in which the latch moves to open the protector guide in the connector device according to an exemplary embodiment of the present disclosure.

### DETAILED DESCRIPTION

An exemplary embodiment of the present disclosure will be described in detail with reference to the accompanying drawings.

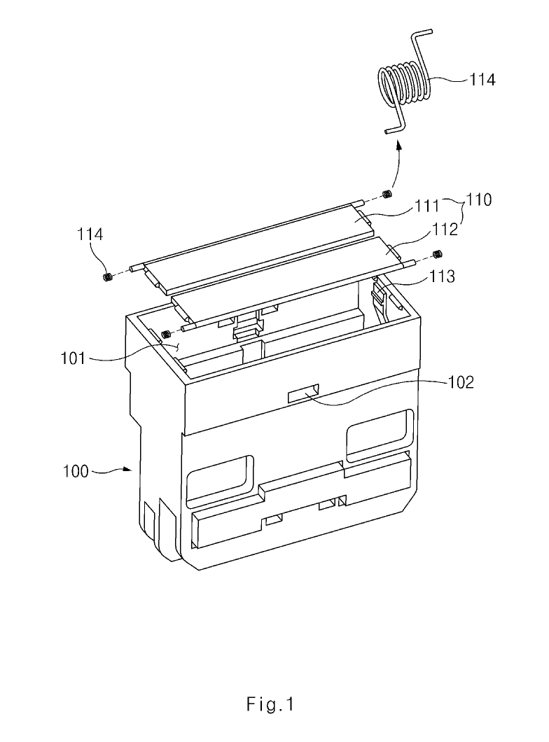

A connector device according to an exemplary embodiment of the present disclosure is configured to include a male connector 100 and a protector guide 110 provided on the male connector 100, as shown in FIGS. 1 to 7(c).

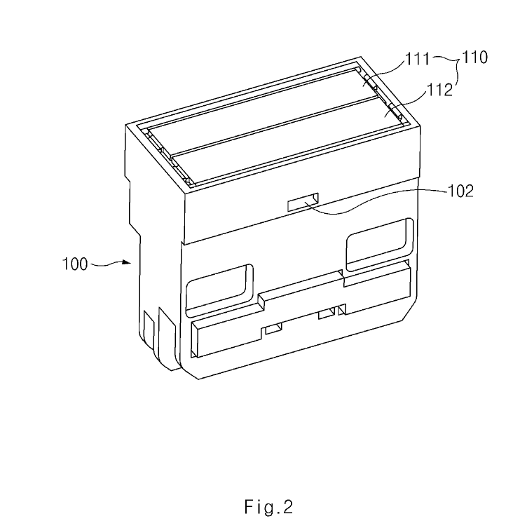

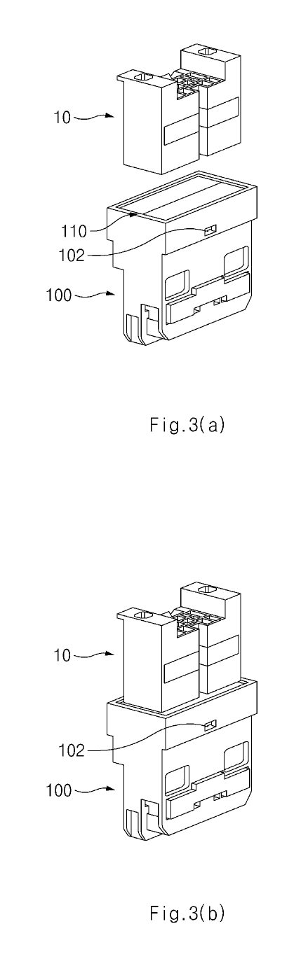

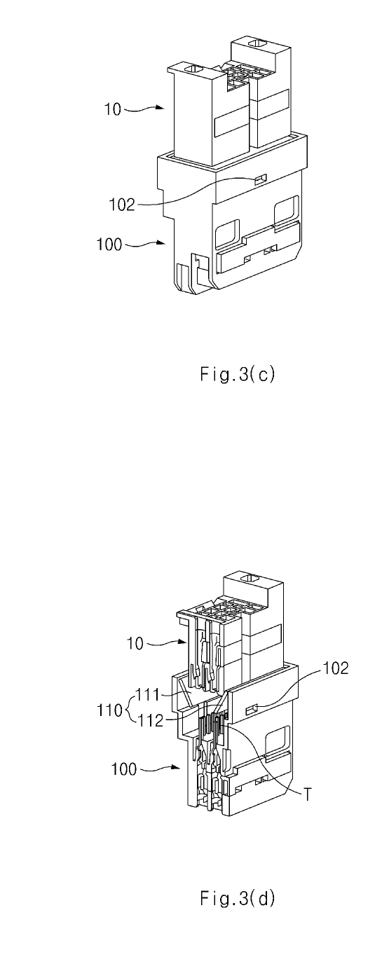

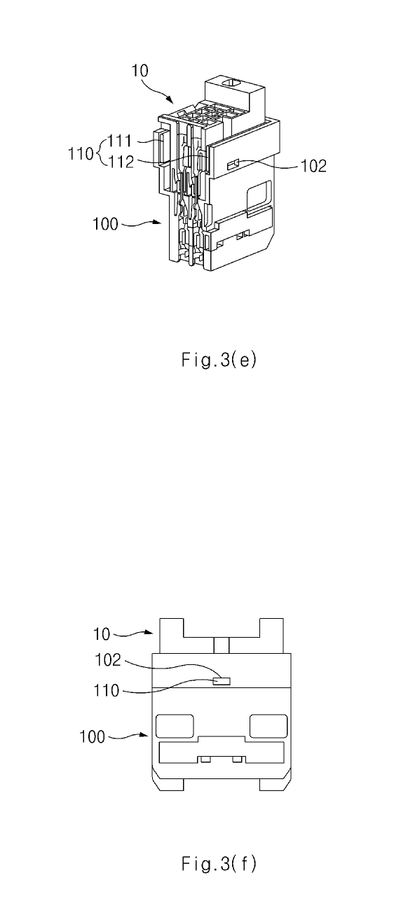

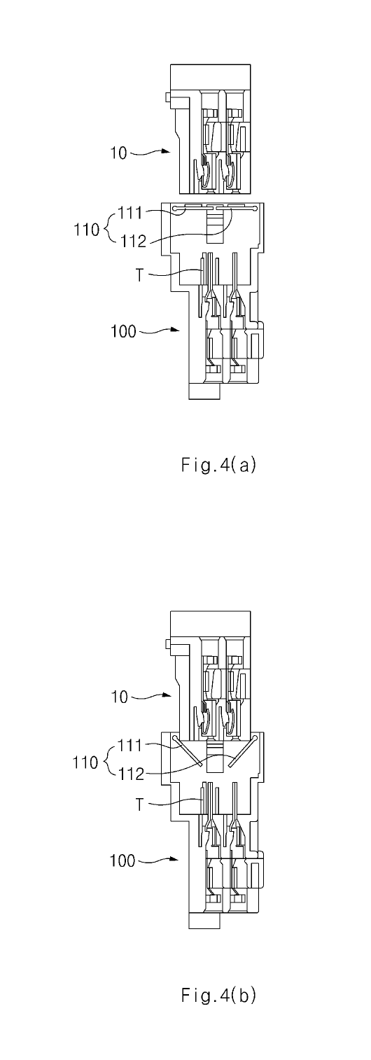

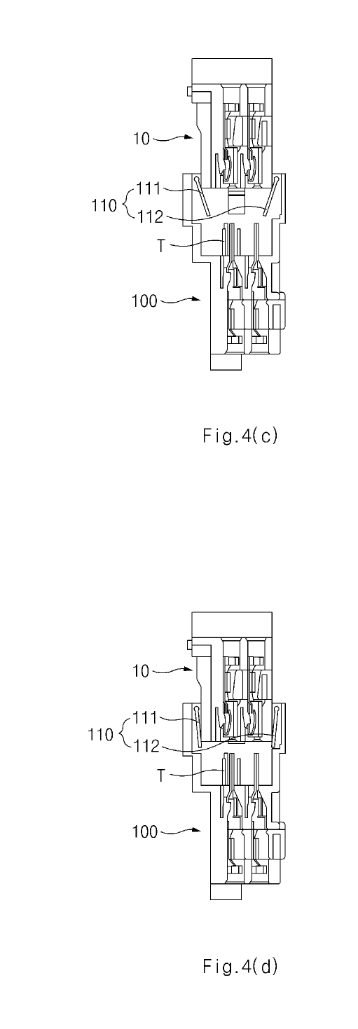

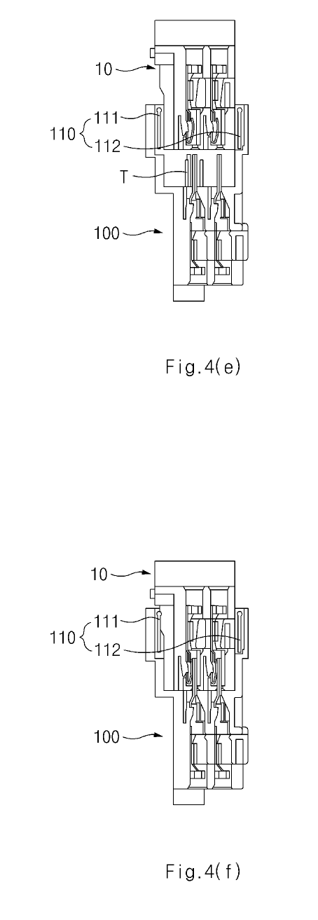

As shown in FIGS. 1 and 2, the male connector 100 is provided with an opening part 101 into which a target connector 10 (See FIGS. 3(a) to 4(f)) or a female connector (hereinafter, referred to as a target connector) may be inserted, and includes terminals T (See FIGS. 3(a) to 4(f)) therein to thereby be connectable to the target connector 10.

The protector guide 110 is provided in the opening part 101 of the male connector 100 so as to be openable or closeable, closes the opening part 101 in a state in which the target connector 10 is not inserted into the male connector 100, thereby blocking deformation of the terminals T by external force and the possibility that foreign materials may be introduced simultaneously with preventing the terminals T of the male connector 100 from being exposed to the outside, and allows the male connector 100 and the target connector 10 to be connected to each other when the target connector 10 is inserted into the male connector 100.

Here, the protector guide 110 includes a first protector guide 111 and a second protector guide 112. The first protector guide 111 and the second protector guide 112 are disposed in parallel with each other and are rotated downward based on the center to thereby be opened or closed.

In addition, shafts 113 are formed at one end of the first protector guide 111 and the other end of the second protector guide 112 and are rotatably mounted in the opening part 101 of the male connector 100.

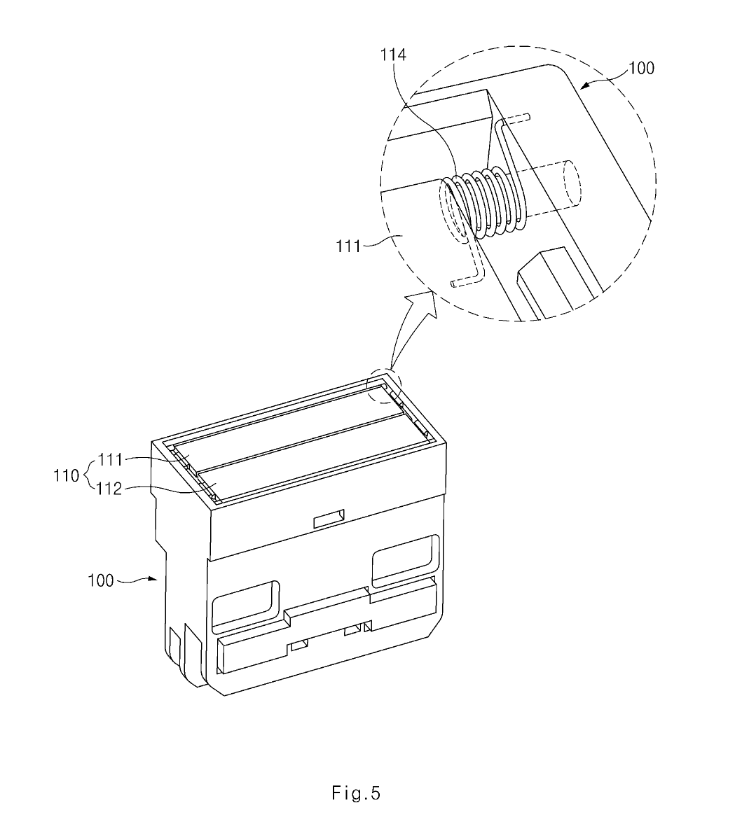

Here, as shown in FIGS. 1 and 5, elastic bodies 114 are mounted on the shafts 113 of the first protector guide 111 and the second protector guide 112 and provide elastic force to the first protector guide 111 and the second protector guide 112. Therefore, the first protector guide 111 and the second protector guide 112 may be rotated downward and opened when external force is applied (when the target connector 10 is inserted into the male connector 100), as shown in FIGS. 3(a) to 4(f) and may be restored to their original positions and be closed when the external force is removed (when the target connector 10 is separated from the male connector 100).

Meanwhile, it is preferable that a through-hole 102 is formed at an outer side of the male connector 100 in which the opening part 101 is formed to allow opening or closing of the protector guide 110 to be confirmed, such that it may be confirmed whether or not the male connector 100 and the target connector 10 are coupled to each other.

That is, the meaning that the protector guide 110 is viewed through the through-hole 102 is that the target connector 10 is inserted into the male connector 100, such that the protector guide 110 is rotated to be closely adhered to a portion adjacent to the through-hole 102 of the opening part 101, and thus, the male connector 100 and the target connector 10 are coupled to each other. The meaning that the protector guide 110 is not viewed through the through-hole 102 is that the target connector 10 is not inserted into the male connector 100, such that the protector guide 110 is not rotated and is not positioned at the portion adjacent to the through-hole 102 of the opening part 101, and thus, the male connector 100 and the target connector 10 are not coupled to each other.

Here, it is preferable that the first protector guide 111 and the second protector guide 112 have a color different from that of the male connector 100 to allow the protector guide 110 to be easily identified at the time of confirming the opening or the closing of the protector guide 110 through the through-hole 102.

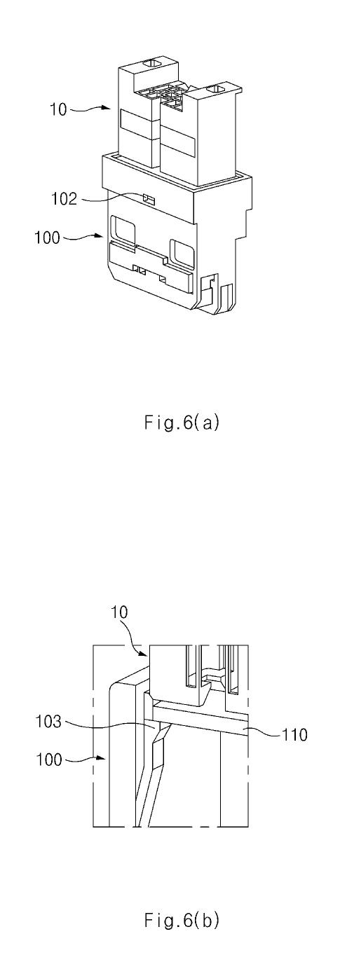

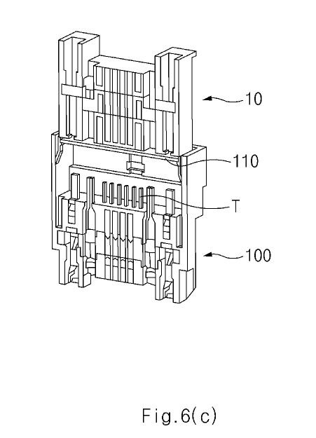

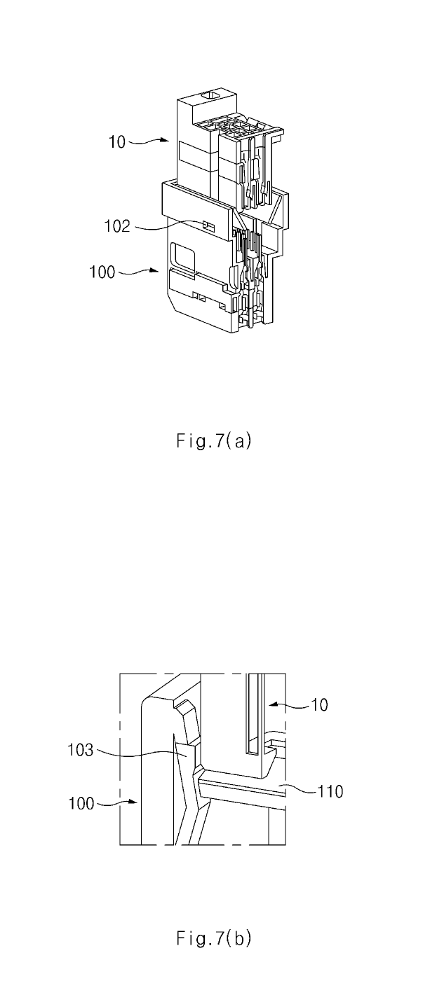

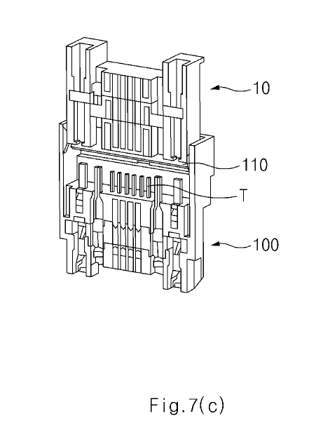

Meanwhile, as shown in FIGS. 6(a) to 7(c), it is preferable that a latch 103 is provided at an inner side of the opening part 101 to limit the opening of the first protector guide 111 and the second protector guide 112, thereby preventing the protector guide 110 from being opened by predetermined external force rather than the insertion of the target connector 10 into the male connector 100.

Here, it is preferable that the latch 103 is movably provided to move the first protector guide 111 and the second protector guide 112 downward at the time of generation of the external force in the first protector guide 111 and the second protector guide 112, that is, only in the case in which the target connector 10 is inserted into the male connector 100, thereby enabling the protector guide 110 to be opened.

Next, an operation sequence of the present disclosure will be described below.

As shown in FIGS. 3(a) and 4(a), the terminals T in the male connector 100 are securely protected from external materials or external force by the protector guide 110 just before the target connector 10 is inserted into the protector guide 110 of the male connector 100.

In this state, when the target connector 10 is inserted into the male connector 100, the target connector 10 opens the protector guide 110 while being inserted into the male connector 100, as shown in FIGS. 3(b) to 3(d) and FIGS. 4(b) to 4(d).

Finally, when the target connector 10 is inserted into the male connector 100 to complete connection while pushing the protector guide 110 to an inner side surface of the opening part 101 as shown in FIGS. 3(e) and 3(f) and FIGS. 4(e) and 4(f), a seated state of the protector guide 110 is confirmed through a color of the protector guide 110 through the through-hole 102 for confirming the connection to enable a worker to visually easily confirm that the connector is completely connected.

As described above, the connector device according to an exemplary embodiment of the present disclosure includes the male connector 100 in which the terminals T are formed, the protector guide 110 provided in the male connector 100 so as to be openable or closeable and including the first protector guide 111 and the second protector guide 112, the shafts 113 formed at one end of the first protector guide 111 and the other end of the second protector guide 112, the elastic bodies 114 mounted on the shafts 113 and providing the elastic force to the first protector guide 111 and the second protector guide 112 to open or close the protector guide 110. Therefore, the protector guide 110 is fixed by the elastic force of the elastic bodies 114 before connecting the target connector 10 to prevent exposure of the terminals T assembled to the connector, thereby making it possible to prevent warpage, deformation, damage, and the like, of the terminals T due to the external force and prevent introduction of external foreign materials, and the target connector 10 may be inserted along an accurate trajectory at the time of connection of the connector to induce accurate connection between the connector and the terminals T, thereby making it possible to improve an assembling property.

In addition, the worker may visually confirm whether or not the connector is completely connected through the rotation of the protector guide 110 having the color different from that of the male connector 100, thereby increasing work convenience.

Further, a structure, in which the protector guide 110 is completely rotated before connection between the terminals T at the time of connection of the connector and is restored to an existing position by the elastic force of the elastic bodies 114 at the time of disconnection of the connector, is used to allow a work process not to be added, thereby making it possible to improve salability.

As set forth above, according to exemplary embodiments of the present disclosure, the protector guide is fixed by the elastic force of the elastic bodies before connecting the target connector to prevent exposure of the terminals assembled to the connector, thereby making it possible to prevent the warpage, the deformation, the damage, and the like, of the terminals due to the external force and prevent the introduction of the external foreign materials, and the target connector may be inserted along the accurate trajectory at the time of connection of the connector to induce the accurate connection between the connector and the terminals, thereby making it possible to improve the assembling property.

In addition, the worker may visually confirm whether or not the connector is completely connected through the rotation of the protector guide having the color different from that of the male connector, thereby increasing the work convenience.

Further, the structure in which the protector guide is completely rotated before connection between the terminals at the time of connection of the connector and is restored to the existing position by the elastic force of the elastic bodies at the time of disconnection of the connector is used to allow the work process not to be added, thereby making it possible to improve the salability.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A connector device comprising:
a male connector having terminals formed therein; and
a protector guide provided in the male connector so as to be openable or closeable.

2. The connector device according to claim 1, wherein the male connector is provided with an opening part, and the protector guide is formed in the opening part.

3. The connector device according to claim 2, wherein the protector guide includes a first protector guide and a second protector guide.

4. The connector device according to claim 3, wherein the first protector guide and the second protector guide are disposed in parallel with each other and are rotated downward based on the center to thereby be opened or closed.

5. The connector device according to claim 4, further comprising shafts formed at one end of the first protector guide and the other end of the second protector guide and rotatably mounted in the opening part.

6. The connector device according to claim 5, further comprising elastic bodies mounted on the shafts and providing elastic force to the first protector guide and the second protector guide to open or close the protector guide.

7. The connector device according to claim 6, wherein a through-hole is formed at an outer side of the male connector in which the opening part is formed to allow the opening or the closing of the protector guide to be confirmed.

8. The connector device according to claim 7, wherein the first protector guide and the second protector guide have a color different from that of the male connector to allow the protector guide to be easily identified at the time of confirming the opening or the closing of the protector guide.

9. The connector device according to claim 5, wherein a latch is provided at an inner side of the opening part to limit opening of the first protector guide and the second protector guide.

10. The connector device according to claim 9, wherein the latch is movably provided to move the first protector guide and the second protector guide downward at the time of generation of external force in the first protector guide and the second protector guide, thereby enabling the protector guide to be opened.

11. A connector device comprising:
a male connector having terminals formed therein;
a protector guide provided in the male connector so as to be openable or closeable and including a first protector guide and a second protector guide; and
shafts formed at one end of the first protector guide and the other end of the second protector guide; and
elastic bodies mounted on the shafts and providing elastic force to the first protector guide and the second protector guide to open or close the protector guide.

12. A connector device, comprising:
a male connector having a housing with an open end and terminals formed inside of the housing; and
a rotatable protector guide coupled to an edge of the open end of the housing.

13. The connector device of claim 12, wherein the rotatable protector guide is rotatable between a first position and a second position.

14. The connector device of claim 13, wherein the terminals is shielded from an exterior of the connector device by the rotatable protector guide at the first position.

15. The connector device of claim 13, wherein a first distance between the rotatable protector guide and the terminals when the rotatable protector guide is positioned at the first position, is greater than a second distance between the rotatable protector guide and the terminals when the rotatable protector guide is positioned at the second position.

16. The connector device of claim 13, wherein the rotatable protector guide is biased by a restore force towards the first position provided by an elastic body, upon offsetting from the first position.
